(19) United States
(12) Patent Application Publication
(10) Pub. No.: US 2015/0164733 A1
(43) Pub. Date: Jun. 18, 2015

(54) DEVICE FOR MASSAGING AND THE APPLICATION OF A COSMETIC COMPOSITION

(71) Applicant: L'OREAL, Paris (FR)

(72) Inventors: Laure Thiebaut, Clichy (FR); Soraya Kadra, Asnieres Sur Seine (FR)

(21) Appl. No.: 14/413,678

(22) PCT Filed: Jul. 5, 2013
(86) PCT No.: PCT/EP2013/064273

§ 371 Date: Jan. 8, 2015

Related U.S. Application Data
(60) Provisional application No. 61/681,785, filed on Aug. 10, 2012.

(30) Foreign Application Priority Data
Jul. 9, 2012 (FR) 1256593

(51) Int. Cl. A61H 15/00; A61H 7/00

(52) U.S. Cl. CPC A61H 15/0092; A61H 7/003

(57) ABSTRACT

The present invention relates to a cosmetic device (1) comprising: —an end-piece (5) comprising a base (2) and at least two elements (4) upstanding from this base, —a body (3) configured to receive the end-piece (5), —a means of rotating the end-piece (5) relative to the body (3) about X an axis (X), in which the end-piece has a profile in cross section in a plane containing (X) which varies during the rotation.

The subject of the present invention is a device for massaging and/or cleansing and/or applying a cosmetic composition to a surface of the body.

According to the invention, “cosmetic device” is understood to mean a device for massaging and/or for cleansing and/or for applying a cosmetic composition.

In particular, this end-piece is particularly advantageous in the field of massaging certain zones of the body and of cleansing the skin, and in particular in deep cleansing for removing impurities from the pores of the skin. It may also be useful in applications for cleansing or for care of the body.

The expression “cosmetic product” is understood to mean a product as defined in Council Directive 93/35/EEC of 14 Jun. 1993.

The application of a cosmetic composition with the aid of an assembly comprising an aerosol container and a device to be mounted on the aerosol container, comprising a rotating massaging member driven by an electric motor, is known from EP 1 728 494.

The invention aims to provide novel ways of massaging and applying certain cosmetic active agents.

Document FR 2 918 545 discloses an assembly for dispensing and applying a cosmetic composition, comprising:
a receptacle containing a cosmetic composition,
an end-piece,
an application device comprising:
   a body configured to receive the receptacle and the end-piece,
   a means for rotating the end-piece relative to the body, and
   a duct for conveying the composition from the receptacle towards an application surface of the applicator.

According to the teaching in this document, the rotation can make it possible to carry out at least one of a massaging action, a skin exfoliation action, and a composition spreading action, which can generate new sensations on application and can improve the effect of one or more active agents of the cosmetic composition.

Also according to this document, it is provided for the end-piece to have massaging reliefs, for example spikes or balls. However, no advantage connected to a particular relief of the end-piece is demonstrated.

Document U.S. Pat. No. 7,469,703 describes a bristled end-piece in the form of a symmetrical dome to be mounted on the body of a body massaging device. On account of this dome shape, the greatest pressure exerted by the end-piece is located in the center of the end-piece during the rotation of the latter. Furthermore, when the end-piece is kept still with respect to a body surface, the pressure exerted by the bristles on a point of this surface is always the same. There is no periodic modification in the contact pressure at a given point during the rotation of the end-piece.

Within the scope of massaging the body or face, end-pieces that provide an improved sensation of well-being while improving blood circulation or lymphatic circulation, so as to produce a decongestant effect, for example in the region of the contour of the eyes, are desired.

Within the scope of cleansing or care of the face, massaging end-pieces which are soft but nevertheless effective for obtaining clean skin, without imperfections, having a uniform complexion and without redness, are desired. To this end, the objective of cleansing the face, in particular for greasy skin or skin prone to acne, is to avoid the proliferation of bacteria, such as P. acnes, in the pores of the skin. For what is known as normal to dry skin, the main objective of cleansing the face is to remove dead skin.

There also exists a need to provide low cost massaging end-pieces, in order that they can be attached to any device for packaging a cosmetic composition, in particular when these devices contain active agents for cleansing the face.

There also exists a need for a massaging end-piece, the operation of which enables different levels of cleansing of the skin.

There also exists a need for a massaging end-piece suited to the hollows and reliefs of a face, in order to enable the cheekbones to be cleansed as well as the sides of the nose.

There are also exists a need for a massaging end-piece which provides new types of sensoriality while correctly applying the cosmetic products or while deep cleansing, and which massages in order to boost blood circulation and lymphatic circulation.

The object of the invention is to solve all or some of the problems identified above by proposing a rotary applicator comprising upstanding elements of variable heights which are distributed on a base in order to alternate on the skin the pressure of the highest elements and the relaxation of the shortest elements.

The subject of the invention is a cosmetic device comprising:

an end-piece comprising a base and at least two elements upstanding from this base,

a body configured to receive the end-piece,

a means of rotating the end-piece relative to the body about an axis (X),
in which the end-piece has a profile in cross section in a plane containing (X) which varies during the rotation,
the rotation axis (X) being perpendicular to the base (2),
each profile in cross section comprising a single maximum.

Advantageously, the end-piece comprises at most one mid-plane of symmetry passing through the axis (X).

According to the invention, the upstanding elements are each terminated by a free end. This end comes into contact with the surface to be treated during the use of the device, in particular into contact with the skin.

With the device according to the invention, it is now possible to alternate the pressure of the upstanding elements on the skin during the rotation of the end-piece, in order to boost circulation.

With the device according to the invention, it is now possible to exert different pressures on contiguous areas of the skin during the movement of the end-piece, in order to carry out a more tonic massage with greater impact. It becomes possible to alternate the application of different pressure levels so as to achieve improved relaxation.

The invention also relates to a cosmetic method comprising the use of the above device.

According to the invention, “mid-plane” is understood to mean a plane perpendicular to the base passing through the axis (X) of rotation of the brush.

A “cross section” is understood to mean a section through the base along a mid-plane.

An “angular space” is understood to mean the angle between two mid-planes which are offset by an angle α about the axis (X).

It is said that “each profile in cross section comprises a single maximum” if each profile in cross section comprises:
either a single highest point or
a single area of highest points. According to a first preferred embodiment of the invention, the maximum is located at one of the two ends of the profile of the cross section.

“The maximum” is the greatest height of an upstanding element measured from the base.

For each cross section, there may exist:
Either a single upstanding element of maximum height,
Or a plurality of upstanding elements of maximum height, in which case these upstanding elements are located next to one another.

According to a second preferred embodiment of the invention, the profile in cross section is composed of two regions:
A first region comprising first upstanding elements all having a first height (h1),
A second region comprising second upstanding elements all having a second height (h2),
the first height being less than the second.

The invention also relates to a kit comprising the above device.

The invention also relates to an end-piece as defined above.

Advantageously, the end-piece has at least two different cross sections spaced angularly. These are obtained by comparing two cross sections of the brush taken in two different mid-planes.

In one particular embodiment, the end-piece has no mid-plane of symmetry passing through the axis (X).

The device according to the invention makes it possible to obtain very satisfactory cleansing and massaging quality by virtue of the fact that, when it is viewed from the side in a direction perpendicular to the rotation axis, the end-piece has a profile which varies when it is rotated about the axis (X).

In one particular embodiment, each cross section of the base passes through at least one extremum between its two lateral ends. This extremum may be a maximum or a minimum and the cross section of the base may in particular pass through one maximum and through one minimum between its two lateral ends.

Advantageously, each cross section of the end-piece has a surface area of between 0.2 cm² and 50 cm², and more particularly between 1 cm² and 20 cm².

Preferably, the edge of each cross section passing through the free ends of the upstanding elements forms a curve.

“Curved” should be understood as meaning “not rectilinear”, such that a broken line is a curved line within the meaning of the present invention.

The edge of the cross section can thus have a greater curvature on one side and a lesser curvature on the other, or else comprise a rectilinear or substantially rectilinear portion and a curved portion.

Preferably, the surface area of the base is greater than 3 cm² and preferably greater than 5 cm². This dimension is specifically suitable for the contours of the face. The surface area is preferably less than 150 cm². Between 30 cm² and 150 cm², the dimension is suitable for the contours of the body (thighs, buttocks, stomach, back, etc.).

Advantageously, the base has a total surface area (S) occupied by the upstanding elements (4), said surface area (S) measuring between 1 cm² and 4 cm² and preferably between 2 cm² and 3 cm².

Massaging and Application Devices

When the end-piece is rotated by the driving means, the speed of rotation of the end-piece may be for example between 150 and 400 rpm, preferably between 200 and 300.

The end-piece may be rotated about a geometric rotation axis which is fixed relative to the body. As a variant, the end-piece may be rotated about a geometric rotation axis which is able to move relative to the body. If necessary, the movement of the end-piece may be an eccentric movement, and this can make it possible to spread the composition more regularly and with a less pronounced border between the treated region and the untreated region, this possibly being advantageous for a self-tanner for example.

The end-piece may be rotated about a geometric rotation axis which forms a zero angle or non-zero angle with the longitudinal axis of the receptacle. A non-zero angle may improve ergonomics.

The end-piece may be mounted removably on the massaging and application device, and this can make it possible to separate the application device in order to clean it and/or to replace it with another end-piece selected depending on the treatment to be carried out or else to throw it away after use.

Material Forming the Upstanding Elements

The upstanding element may comprise a cellular material which may be elastically deformable and/or compressible. This material may be a foam. The foam may be produced from a material selected from the following list: Polyurethane, polyether, polyester, polyvinyl chloride, polyethylene, EVA, latex, silicone, SIS, SEBS, silicone elastomer, latex elastomer, nitrile elastomer, butyl elastomer, Neoprene®, NBR, SBR, this list not being limiting.

The upstanding element may have a composite structure having a plurality of layers having different natures, for example a number of types of foam.

The upstanding element may have any shape. It may have a circular, oval or polygonal cross section, for example a triangular, square, hexagonal, etc. cross section.

The upstanding element may have abrasive properties. “Abrasive property” should be understood as meaning a surface which, when moved over the skin, removes at least some of the dead cells from the surface.

Such surfaces can be characterized by an abrasive power of between 0.01 and 0.03 g/cm²/min. The abrasive power corresponds to the quantity of plaster removed per minute, per square centimetre of an abrasive surface applied to a square of plaster having a thickness of 50 mm using a 135W Black and Decker CD 400 sander, the pressure exerted on the square of plaster resulting from the weight of the sander, only the movement of which in the plane of the abrasive surface is constrained.

Such upstanding elements are obtained either by taking a substantially rigid cellular material, or by incorporating hard grains into a flexible cellular material.

An example of an abrasive surface is a nonwoven exfoliating pad sold by 3M.

The foam may be a soft and flexible foam particularly suitable for spreading the product, sometimes also known as a sponge.

The upstanding element may be for example a hydrophilic crosslinked polyester foam, for example having a density equal to 32 kg/m³.

A sponge traditionally used for applying foundation, such as NBR, for example Yukilon® from Penthouse Group is also conceivable.

The upstanding element may be a thermocompressed foam. Thermocompression makes it possible to create reliefs on the surface of the foam and/or to complex it with an elastic fabric, thereby making it possible to have the flexibility of the foam but the feel of a textile more pleasant than that of plastic.

An example of a thermocompressed foam is a closed-cell foam made of polyolefin, for example thermocompressed polyethylene having a specific weight of 33 kg/m³, which is for example complexed with an elastic fabric such as for example Lycra®.

The upstanding element may be a file made of plastics material, metal or glass.

The upstanding element may be made of injection-molded flexible plastics material, for example of elastomer, and have massaging reliefs, for example spikes having pointed ends, rounded ends, a round, square, or triangular cross section, a length of between 1 mm and 40 mm for example, or balls having a round or oval cross section and a height of between 1 mm and 20 mm for example.

The upstanding element is for example made of an elastomer such as SEBS or silicone.

The upstanding element may be a brush made of synthetic or natural bristles, for example a bristled brush having tufts of strands of polyamide or PBT for example having a diameter of between 0.05 and 0.2 mm and more particularly made of Nylon® 6.12 having a diameter of 0.075 mm, which have been milled and ground in order to make them very soft in contact with the skin.

Implantation of the Upstanding Elements

The “end of the upstanding element” is understood to mean the point of the upstanding element which is farthest from the base and located on their main extension axis starting from their zone of attachment to the base in the direction of their free end.

The “height of the upstanding element” is understood to mean the distance measured along their main extension axis in the direction of their free end. Preferably, the height of the upstanding elements is between 0.1 and 3 cm.

The “thickness of the upstanding element” is understood to mean the maximum cross section of the upstanding element measured at their zone of attachment to the base. Preferably, the thickness of the upstanding elements is between 0.1 mm and 0.5 cm.

Advantageously, the device comprises upstanding elements such that the difference in height between two elements of extreme size is greater than 0.2 cm, preferably greater than 1 cm, and more preferably greater than 1.5 cm. This difference makes possible the efficacious alternation on the skin of the highest elements and the relaxation of the shortest elements.

The invention also relates to an assembly comprising a cosmetic receptacle comprising a through-hole in which an end-piece as defined above is housed.

In particular, this receptacle may be a tube or a bottle.

“The two elements of extreme size” are understood to be the element on the base having the maximum height and the element on the base having the minimum height.

The invention may be better understood on reading the following description of non-limiting implementation examples thereof, and with reference to the attached drawing, in which:

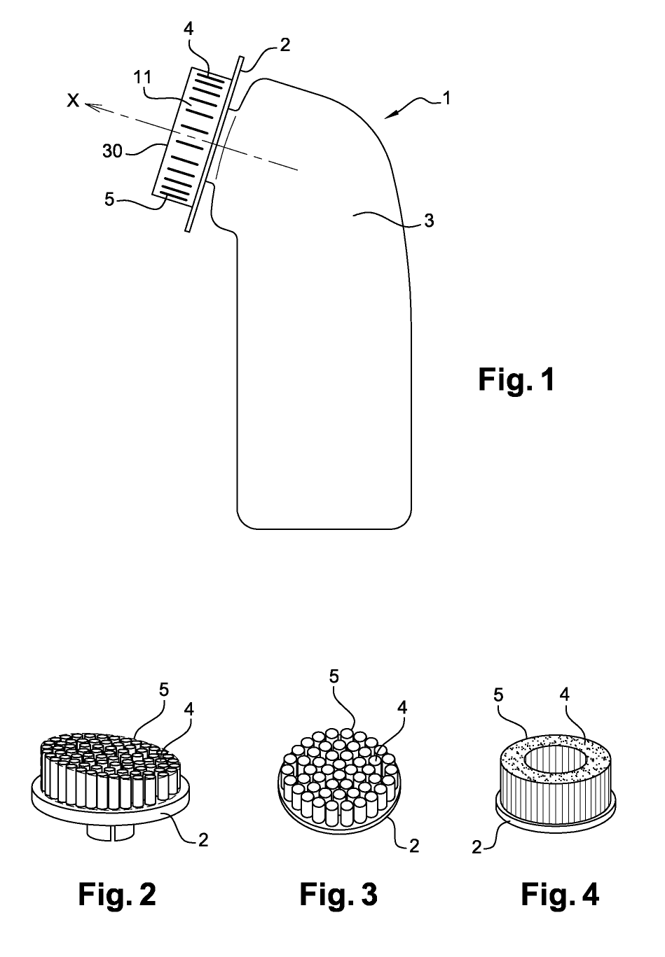

FIG. 1 schematically shows a front view of an example of a device according to the invention,

FIG. 2 is a schematic perspective view of an end-piece according to the invention,

FIG. 3 is a schematic perspective view of an end-piece according to the prior art,

FIG. 4 is a schematic perspective view of an end-piece according to the prior art,

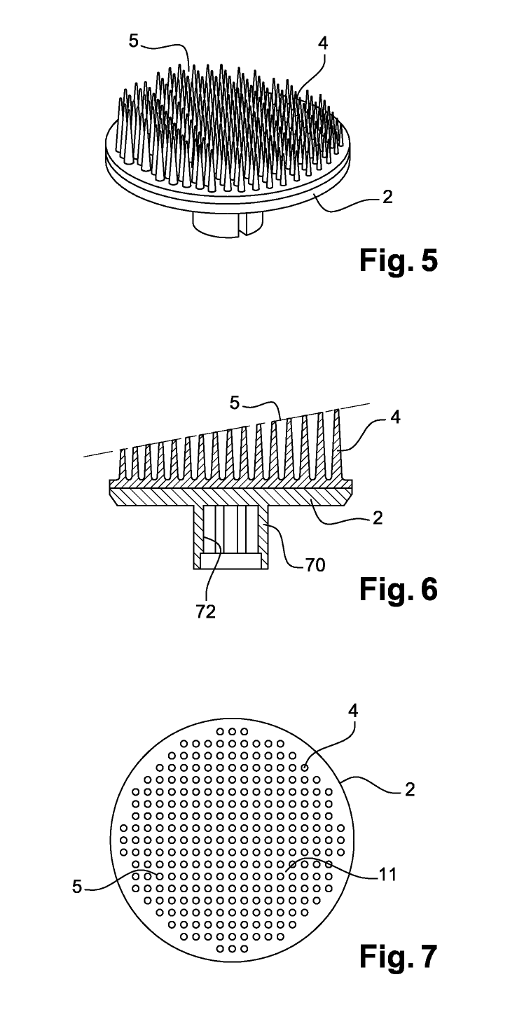

FIG. 5 is a schematic perspective view of another end-piece according to the invention,

FIG. 6 is a schematic view in section AA of the end-piece from FIG. 5,

FIG. 7 is a schematic top view of the end piece from FIG. 5,

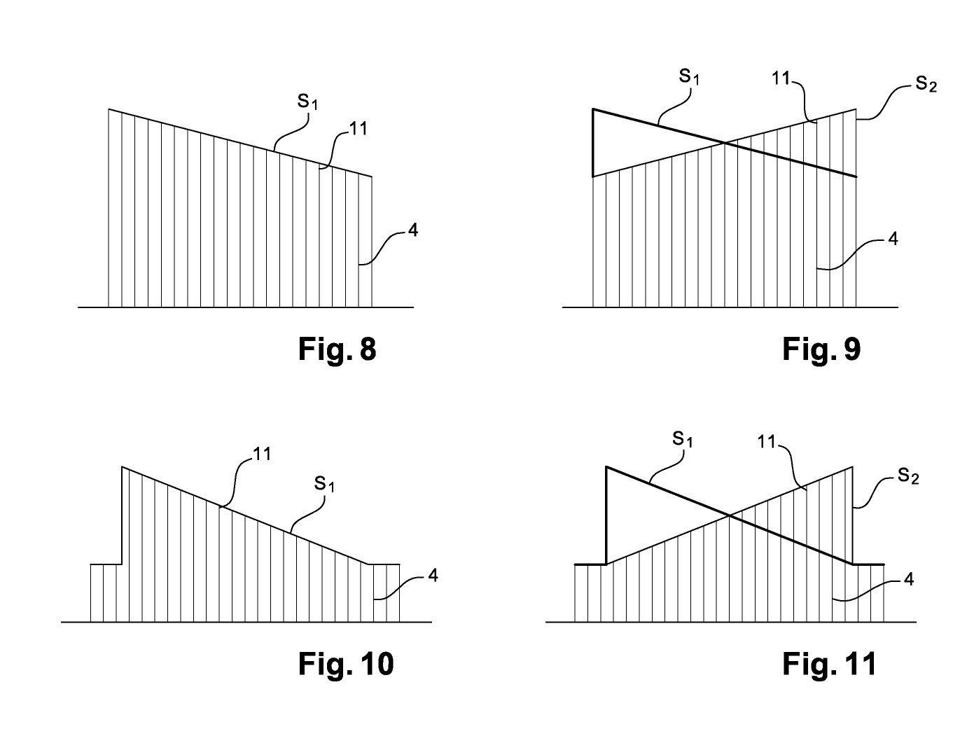

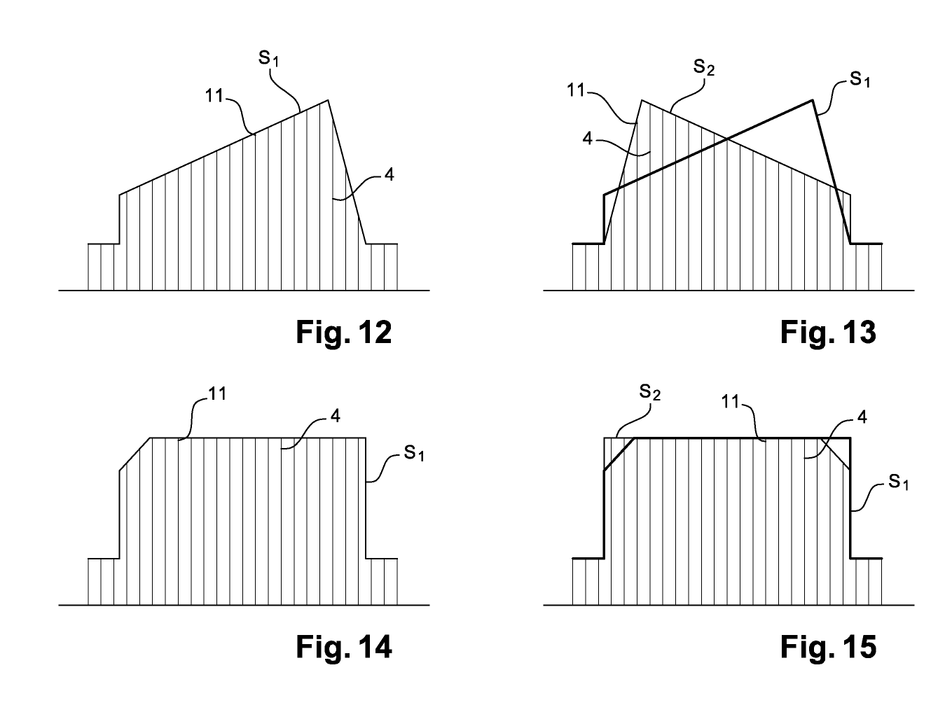

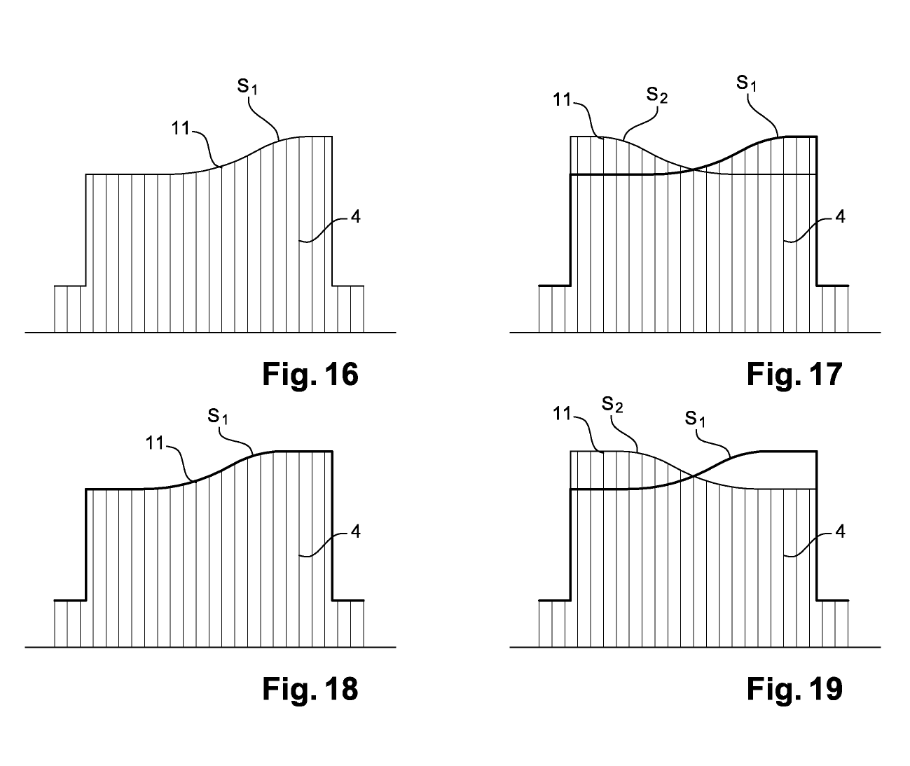

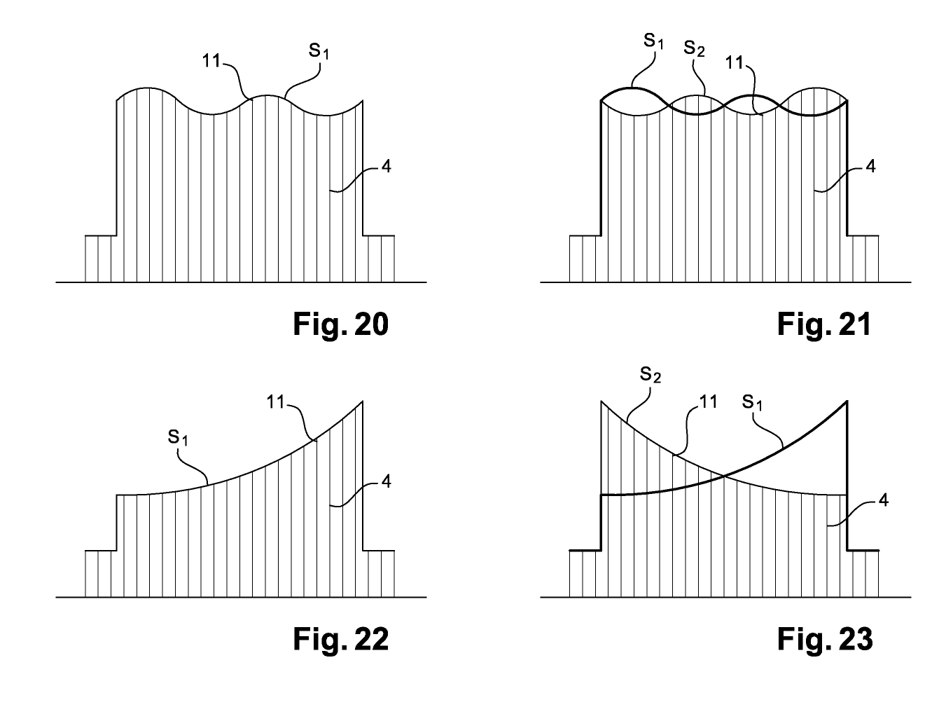

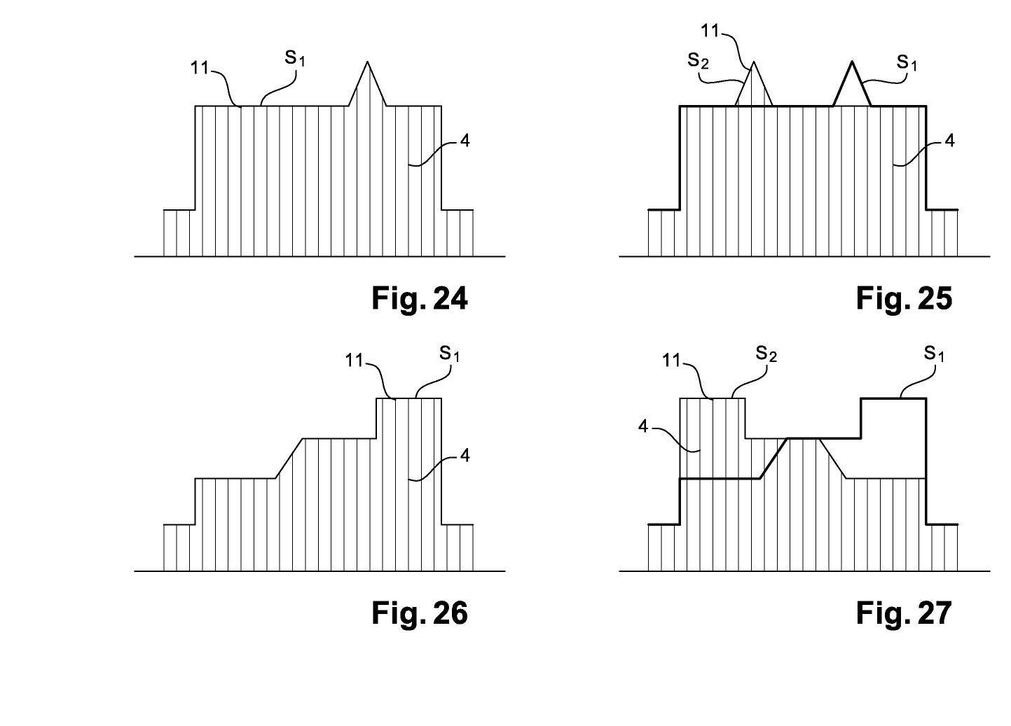

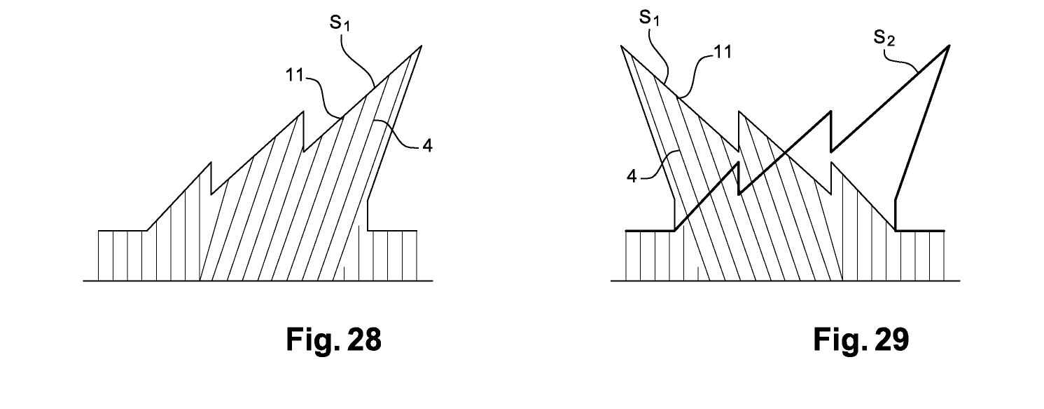

For the following FIGS. 8 to 29:

each even-numbered figure shows on its own a profile of an end-piece according to the invention when it is viewed from the side in a direction perpendicular to the axis (X) before it is set in rotation, and

each odd-numbered figure shows on its own a profile of the same end-piece as the even-numbered figure when it is viewed from the same point as the even-numbered figure but following a half rotation.

FIG. 1 shows a device 1 produced in accordance with the invention.

This device 1 comprises a body 3 on which there may be an end-piece 5 defining an application surface intended to come into contact with the skin.

The device 1 is for example produced in accordance with patent application US 2006/0276731.

The body 3 may house means for driving the end-piece 5 in a rotational movement relative to the body 3.

This movement is for example a rotational movement about a rotation axis X which is fixed relative to the body 3.

The driving means may comprise an electric motor which is housed in the body 3, is supplied by one or more batteries, and rotates the end-piece about the axis X by way of gears. The motor may also be driven by a battery or rechargeable battery.

In the example illustrated in FIG. 1, the end-piece 5 comprises upstanding elements 4 defining the application surface 30. The upstanding elements are fixed to a base 2 and are terminated by their free end 11.

In the example in FIG. 2, the end-piece is in accordance with the invention. The free ends of the application elements define an inclined surface. The inclination is 10° with respect to the base 2. When this end-piece is set in rotation, the shape of this surface changes. It retains its oblique shape but changes direction. It regains its shape on each rotation.

The end-piece has a profile (S) which varies when it is rotated about the axis (X) and when it is viewed from the side in a direction perpendicular to the rotation axis (X).

In the example in FIG. 3, the end-piece is in accordance with the prior art. The free ends of the application elements define a surface in the shape of a dome. When this end-piece is set in rotation, this surface always preserves this dome shape.

The end-piece has a profile (S) which does not vary when it is rotated about the axis (X) and when it is viewed from the side in a direction perpendicular to the rotation axis (X).

In the example in FIG. 4, the end-piece is in accordance with the prior art. The free ends of the application elements define a surface in the shape of a flat. When this end-piece is set in rotation, this surface always preserves this flat shape.

The end-piece has a profile (S) which does not vary when it is rotated about the axis (X) and when it is viewed from the side in a direction perpendicular to the rotation axis (X).

In the example in FIG. 5, the end-piece is in accordance with the invention. This is the same end-piece as that in FIG. 2, except that the upstanding elements are spikes instead of being tufts of bristles. When this end-piece is set in rotation, the shape of the profile changes.

FIG. 6 shows the end-piece from FIG. 5 in a side view. The base 2 is produced in one piece with the plate 70, provided with a hook 72 for coupling it to a driving member of the application device. The transmission of movement may take place in various other ways, for example by complementing shapes or by friction.

FIG. 7 is a top view of the end piece from FIG. 5. It shows the free ends 11 of the application elements.

FIGS. 8 to 29 should be considered in pairs:

Each even-numbered figure shows the profile of the end-piece before the end-piece is set in rotation. This profile is referred to as S₁.

Each odd-numbered figure shows the profile S₁ and the profile S₂. The profile S₂ represents the profile of the end-piece following a half rotation.

For each end-piece, it can be seen that the profiles S₁ and S₂ are distinct.

Put simply, a change in shape following a half rotation is shown here.

The end-pieces in FIGS. 8 to 29 have a profile (S) which varies when it is rotated about the axis (X) and when it is viewed from the side in a direction perpendicular to the rotation axis (X). These are end-pieces in accordance with the invention.

In order to use the device according to the invention, it is possible for example to apply a composition without the end-piece being rotated, and this can make it possible for example to spread the composition over the region to be treated. The end-piece is then rotated in order to massage the region to which the composition has been applied.

In another example, the end-piece is rotated in order to massage the region to be treated, without a composition being dispensed.

In yet another example, the end-piece is rotated in order to massage the region to be treated, without a composition being dispensed at first.

The massaging action may result in local heating on account of the friction of the end-piece on the skin for example, and the absence of the composition on the end-piece initially may increase the friction and the sensation of heat that results therefrom.

Next, while the end-piece is still being rotated or, as a variant, while the end-piece is at a standstill, the composition may be dispensed and spread over the region previously massaged.

In the entire description, the expression “comprising a” should be considered as being synonymous with “comprising at least one”, unless specified to the contrary.

1-10. (canceled)

11. A cosmetic device, comprising:
an end-piece comprising a base and at least two elements upstanding from the base;
a body configured to receive the end-piece; and
a means of rotating the end-piece relative to the body about an axis,
wherein the end-piece has a profile in cross section in a plane containing the axis that varies during rotation, the rotation axis being perpendicular to the base, and each profile in cross section comprising a single maximum.

12. The device according to claim 11, wherein the end-piece comprises at most one mid-plane of symmetry passing through the axis.

13. The device according to claim 11, wherein the end-piece comprises at least two upstanding elements such that the difference in height between two elements of extreme size is greater than about 0.2 cm.

14. The device according to claim 11, wherein the end-piece has substantially no mid-plane of symmetry passing through the axis.

15. The device according to claim 11, wherein the base has a total surface area occupied by the at least two upstanding elements, said surface area measuring between about 1 cm² and about 4 cm².

16. The device according to claim 11, wherein the end-piece has at least two different cross sections spaced angularly.

17. The device according to claim 11, wherein each cross section of the base passes through at least one extremum between two lateral ends of the base.

18. The device according to claim 11, wherein the end-piece comprises at least two upstanding elements such that the difference in height between two elements of extreme size is greater than about 1 cm.

19. The device according to claim 11, wherein the end-piece comprises at least two upstanding elements such that the difference in height between two elements of extreme size is greater than about 1.5 cm.

20. The device according to claim 11, wherein the base has a total surface area occupied by the at least two upstanding elements, said surface area measuring between about 2 cm² and about 3 cm².

21. A method of massaging a portion of the body, cleansing and/or caring for the skin, and/or application of a cleansing and/or care product to the body and/or skin, said method comprising massaging said portion of the body, cleansing and/or caring for the skin, and/or application of a cleansing and/or care product to the body and/or skin with a cosmetic device comprising:
an end-piece comprising a base and at least two elements upstanding from the base;
a body configured to receive the end-piece; and
a means of rotating the end-piece relative to the body about an axis,
wherein the end-piece has a profile in cross section in a plane containing the axis that varies during rotation, the rotation axis being perpendicular to the base, and each profile in cross section comprising a single maximum.

22. A kit comprising a cosmetic device, the cosmetic device comprising:
an end-piece comprising a base and at least two elements upstanding from the base;
a body configured to receive the end-piece; and
a means of rotating the end-piece relative to the body about an axis,
wherein the end-piece has a profile in cross section in a plane containing the axis that varies during rotation, the rotation axis being perpendicular to the base, and each profile in cross section comprising a single maximum.

23. An assembly comprising:
a cosmetic receptacle including a through-hole in which an end-piece is housed, the end-piece comprising:
a base and at least two elements upstanding from the base,
wherein the end-piece is configured to be received by a body and to rotate relative to the body about an axis, and
wherein the end-piece has a profile in cross section in a plane containing the axis that varies during rotation, the rotation axis being perpendicular to the base, and each profile in cross section comprising a single maximum.
